(19) United States
(12) Patent Application Publication
(10) Pub. No.: US 2021/0012562 A1
(43) Pub. Date: Jan. 14, 2021

(54) PROBE-BASED DYNAMIC GLOBAL ILLUMINATION

(71) Applicant: NVIDIA Corporation, Santa Clara, CA (US)

(72) Inventors: Morgan McGuire, Williamstown, MA (US); Alexander Majercik, San Francisco, CA (US); David Patrick Luebke, Charlottesville, VA (US)

(21) Appl. No.: 16/926,529

(22) Filed: Jul. 10, 2020

Related U.S. Application Data
(60) Provisional application No. 62/986,337, filed on Mar. 6, 2020.
(60) Provisional application No. 62/873,101, filed on Jul. 11, 2019.

(51) Int. Cl. G06T 15/50; G06T 15/80; G06T 15/10

(52) U.S. Cl. CPC G06T 15/506; G06T 15/10; G06T 15/80

(57) ABSTRACT

Global illumination in computer graphics refers to the modeling of how light is bounced off of one or more surfaces in a computer generated image onto other surfaces in the image (i.e. indirect light), rather than simply determining the light that hits a surface in an image directly from a light source (i.e. direct light). Rendering accurate global illumination effects in such images makes them more believable. However, simulating physically-based global illumination with offline numerical solvers has traditionally been time consuming and/or noisy and has not adapted well for dynamic scenes. The present disclosure provides a probe-based dynamic global illumination technique for computer generated scenes.

### CLAIM OF PRIORITY

This application claims the benefit of U.S. Provisional Application No. 62/873,101 (Attorney Docket No. NVIDP1274+/19-TR-0175US01) titled “RAY TRACED IRRADIANCE FIELD PROBES WITH VISIBILITY INFORMATION,” filed Jul. 11, 2019, and further claims the benefit of U.S. Provisional Application No. 62/986,337 (Attorney Docket No. NVIDP1274A+/19-TR-0175US02) titled “SCALING PROBE-BASED REAL-TIME DYNAMIC GLOBAL ILLUMINATION FOR PRODUCTION IN RTXGI,” filed Mar. 6, 2020, the entire contents of which are incorporated herein by reference.

### TECHNICAL FIELD

The present disclosure relates to global illumination in computer graphics.

### BACKGROUND

Global illumination in computer graphics refers to the modeling of how light is bounced off of one or more surfaces in a computer generated image onto other surfaces in the image (i.e. indirect light), rather than simply determining the light that hits a surface in an image directly from a light source (i.e. direct light). Rendering accurate global illumination effects in such images makes them more believable. However, simulating physically-based global illumination with offline numerical solvers has traditionally been time consuming and/or noisy and has not adapted well for dynamic scenes.

In real-time rendering, significant work on generating convincing real-time global illumination effects has lead to many different solutions, each with specific tradeoffs between accuracy, flexibility, and performance. For example, light probes may be placed densely inside the volume of a scene, each of which encodes some form of a spherical irradiance map. However, techniques involving light probes require manual adjustment of placement in order to avoid light and dark (i.e. shadow) leaks, such as through walls, or to avoid displaced reflection artifacts. Light field probes, on the other hand, resolve many light/dark leaking issues by encoding additional information about the scene geometry into spherical probes. However, light field probes are typically precomputed, such that only fixed lighting and geometric conditions can be handled. Moreover, their sampling schemes can lead to aliasing and light-leaking in the diffuse and specular indirect illumination.

There is a need for addressing these issues and/or other issues associated with the prior art.

### SUMMARY

A method, computer readable medium, and system are disclosed for probe-based dynamic global illumination. In use, an irradiance field probe of a plurality of irradiance field probes placed in a volume of a scene is computed. The irradiance field probe is computed by: computing a diffuse irradiance and a mean and variance of a distance distribution, and further encoding the irradiance field probe with the diffuse irradiance and the mean and variance of the distance distribution.

### BRIEF DESCRIPTION OF THE DRAWINGS

FIG. 1 illustrates a flowchart of a method for computing irradiance field probes placed in a volume of a scene, in accordance with an embodiment.

FIG. 2A illustrates a flowchart of a method for dynamically updating irradiance field probes placed in a volume of a scene, in accordance with an embodiment.

FIG. 2B illustrates a block diagram showing the shading of a surfel when updating an irradiance field probe during the method of FIG. 2A, in accordance with an embodiment.

FIG. 2C illustrates probe states and state transitions, in accordance with an embodiment.

FIG. 2D illustrates compute shader indexing, in accordance with an embodiment.

FIG. 2E illustrates volume indexing, in accordance with an embodiment.

FIG. 2F illustrates probe initialization and motion around a camera tracked volume.

FIG. 2G illustrates Blending between multiple volumes.

FIG. 3 illustrates a parallel processing unit, in accordance with an embodiment.

FIG. 4A illustrates a general processing cluster within the parallel processing unit of FIG. 3, in accordance with an embodiment.

FIG. 4B illustrates a memory partition unit of the parallel processing unit of FIG. 3, in accordance with an embodiment.

FIG. 5A illustrates the streaming multi-processor of FIG. 4A, in accordance with an embodiment.

FIG. 5B is a conceptual diagram of a processing system implemented using the PPU of FIG. 3, in accordance with an embodiment.

FIG. 5C illustrates an exemplary system in which the various architecture and/or functionality of the various previous embodiments may be implemented.

FIG. 6 is a conceptual diagram of a graphics processing pipeline implemented by the PPU of FIG. 3, in accordance with an embodiment.

FIG. 7 is a block diagram of an example game streaming system suitable for use in implementing some embodiments of the present disclosure.

FIG. 8 is a block diagram of an example computing device suitable for use in implementing some embodiments of the present disclosure.

### DETAILED DESCRIPTION

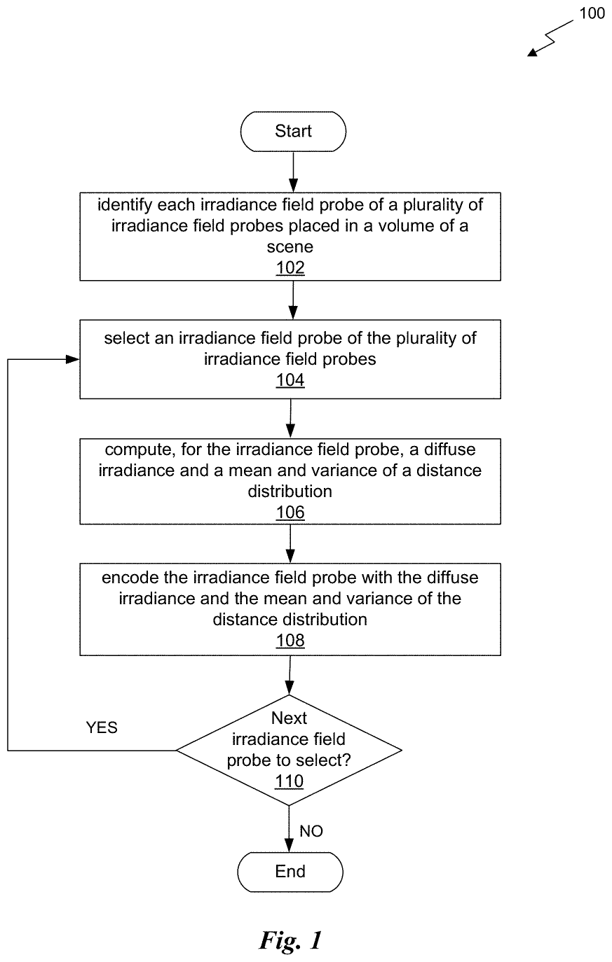

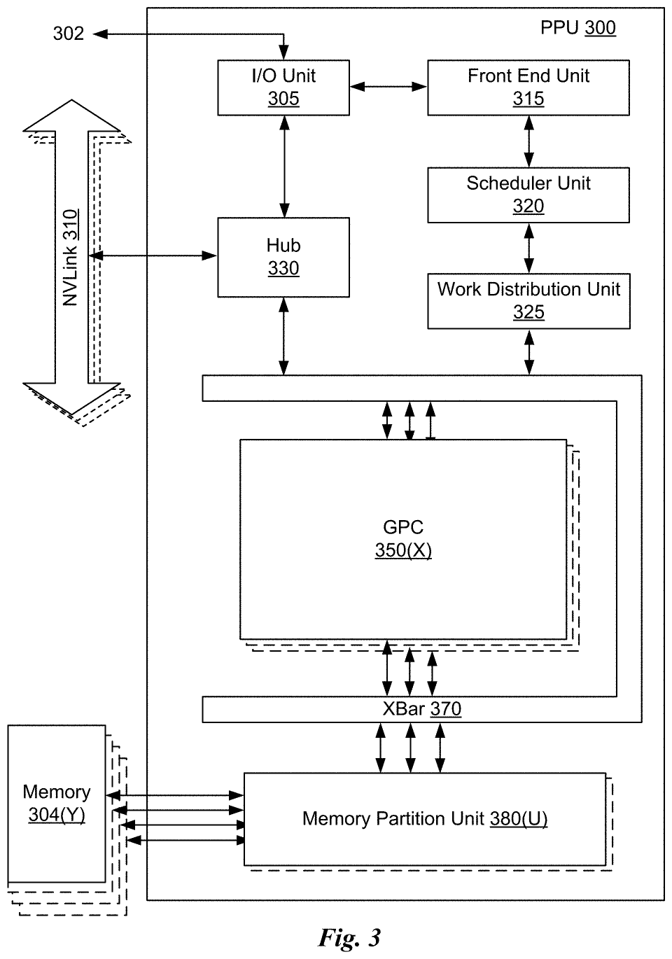

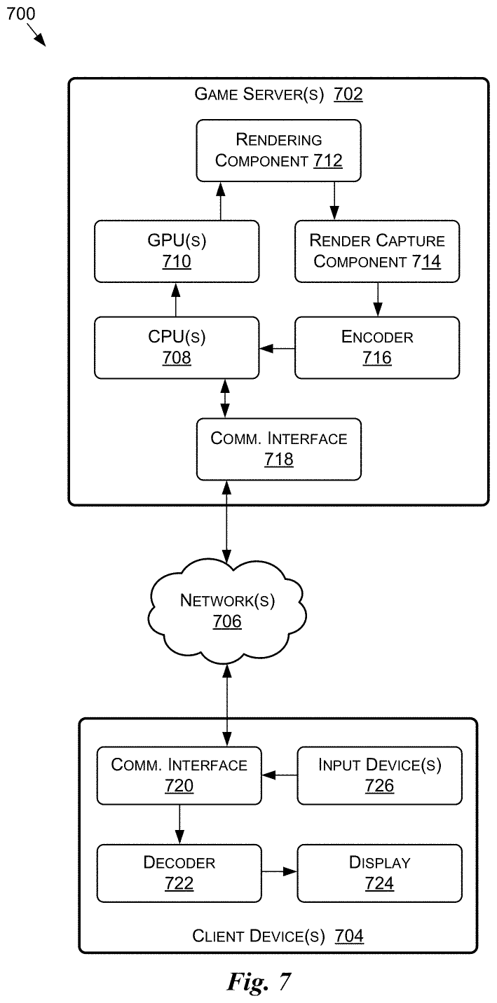

FIG. 1 illustrates a flowchart of a method 100 for computing irradiance field probes placed in a volume of a scene, in accordance with an embodiment. The method 100 may be performed at scene initialization. Additionally, the method 100 may be performed by one or more (e.g. parallel) processing units, such as using the hardware described below with reference to FIGS. 3-6. For example, the method 100 may be carried out by a GPU (graphics processing unit), CPU (central processing unit), or any processor. As a further option, the method 100 may be carried out in the context of the game streaming system 700 described below with reference to FIG. 7. Furthermore, persons of ordinary skill in the art will understand that any system that performs the operations of the method 100 is within the scope and spirit of embodiments of the present disclosure.

As shown in operation 102, each irradiance field probe of a plurality of irradiance field probes placed in a volume of a scene is identified. The scene is a computer generated scene. Further, the irradiance field probes are placed in the volume of the scene for use in providing global illumination for the scene.

In one embodiment, the irradiance field probes may be placed as a three-dimensional (3D) grid within the volume of the scene. In another embodiment, each identified irradiance field probe may be visualized as a sphere, and may store information about a point in the scene. Optionally, at least a subset of the irradiance field probes may be volumes of different resolutions. It should be noted that this operation 102 is optional, and thus may not be required prior to computing an irradiance field probe placed in a volume of a scene.

Additionally, as shown in operations 104-110, one or more irradiance field probes of the plurality of irradiance field probes are computed. In particular, in operation 104, an irradiance field probe is selected for computation. Operations 106-108 are then performed to compute the selected irradiance field probe. Any next (or additional) irradiance field probe, as determined in decision 110, is then selected for computation and operations 106-108 are repeated for the newly selected irradiance field probe. The irradiance field probes may be selected based on a determination (e.g. using indexing match) of which of the irradiance field probes are to be used for shading.

With respect to operation 106, a diffuse irradiance and mean and variance of a distance distribution is computed for the irradiance field probe. In one embodiment, the mean and variance of the distance distribution may be encoded as an average distance and average square distance (i.e. to the nearest geometry in each direction). Still yet, in operation 108, the irradiance field probe is encoded with the diffuse irradiance and the mean and variance of the distance distribution.

To this end, the each irradiance field probe is not only encoded with the lighting information (i.e. diffuse irradiance), it is also explicitly encoded with visibility information (i.e. mean and variance of the distance distribution). In one embodiment, the encoding may be performed by packing the diffuse irradiance and the mean and variance of the distance distribution as square probe textures into a single two-dimensional (2D) texture atlas with duplicated gutter regions. In another embodiment, the irradiance field probe may be encoded by applying a perception-based exponential encoding to probe irradiance values.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

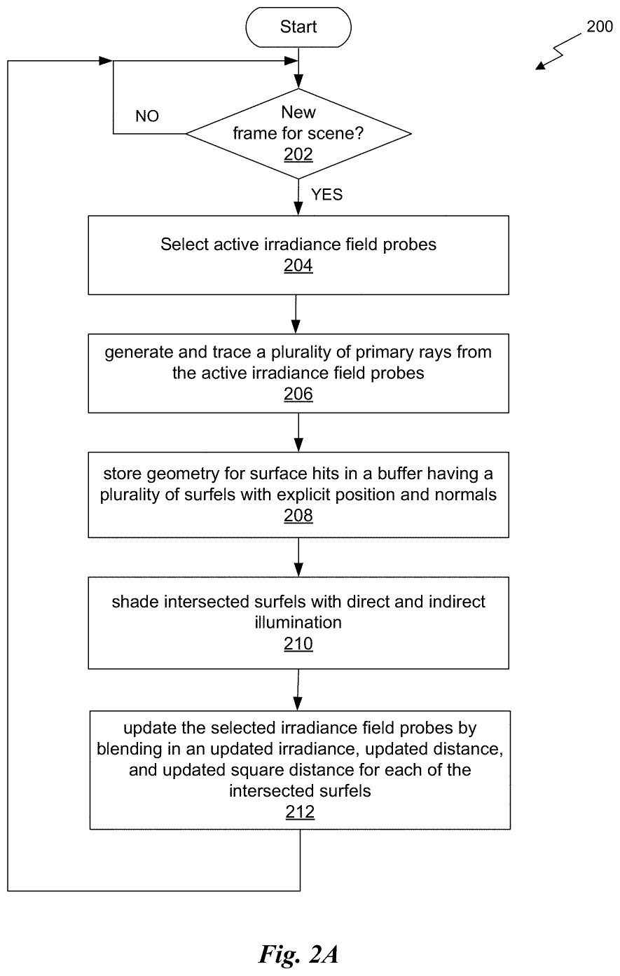

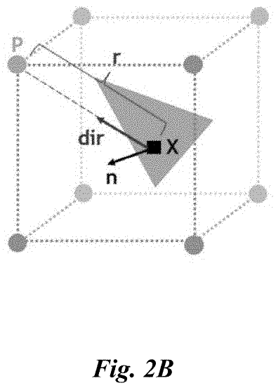

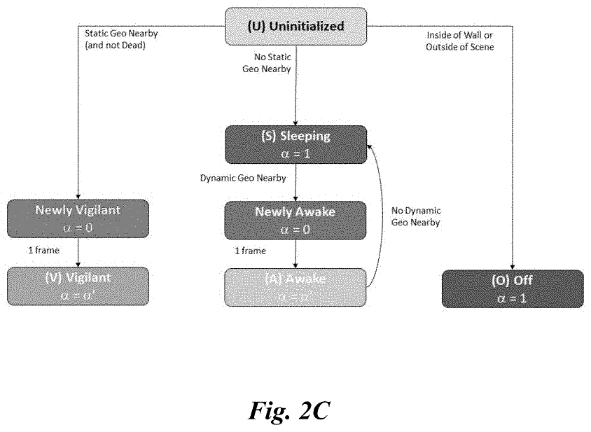

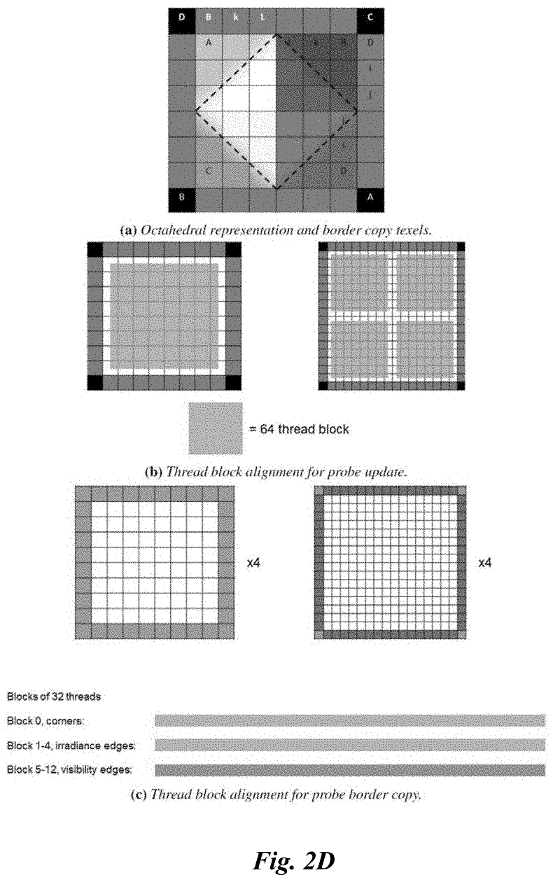

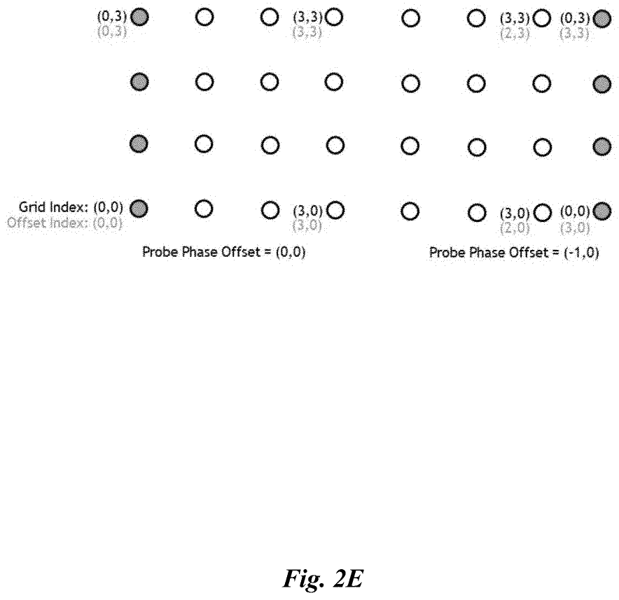

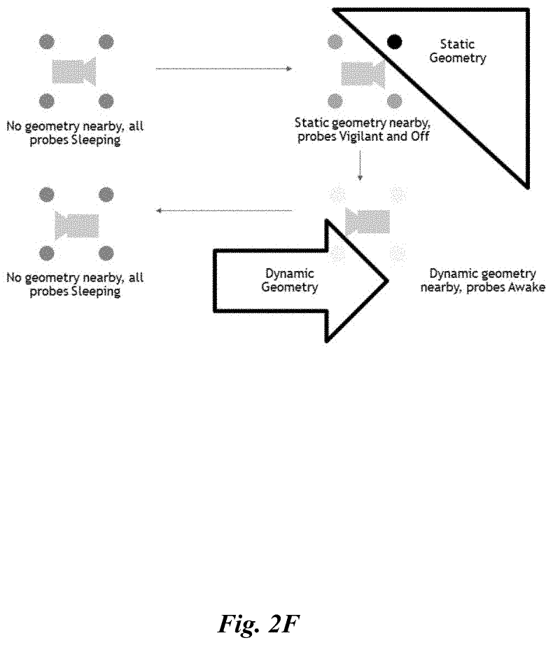

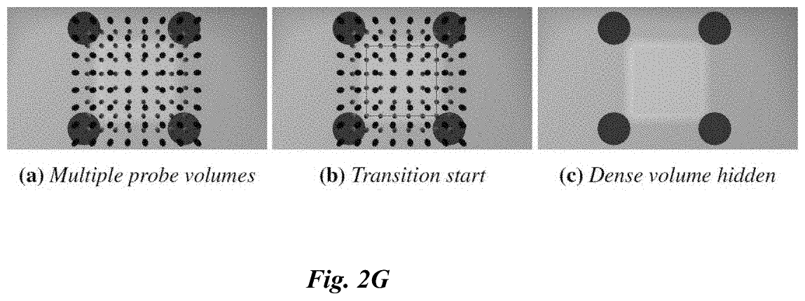

FIG. 2 illustrates a flowchart of a method 200 for dynamically updating irradiance field probes placed in a volume of a scene, in accordance with an embodiment. The irradiance field probes may be those described above with reference to FIG. 1, for example. Thus, the method 200 may be performed after scene initialization. During initialization, the irradiance field probes may be placed in a volume of the scene, and then computed. There is no need for manual probe placement due to the visibility-aware sampling of probe data described below.

These probes may be placed at the vertices of an axis-uniform 3D grid. Using a power-of-two resolution per axis, probe indexing may be simplified to simple bitwise operations. Per-axis grid cell spacing may be scaled independently for scenes that require different spatial discretization per axis. The visibility-aware probe selection described below and the sampling may afford certain latitude when placing probes: probes that fall inside walls or other geometry may be ignored by visibility-query metrics. Also, other than simplifying probe indexing, no aspect of the probe generation or shading may require a uniform grid placement. Of course, in other embodiments the probes can be placed according to other schemes, such as tetrahedral grids.

Every point in space may be associated with a cage of vertices corresponding to the eight vertices of the grid cell that contains the point. A grid resolution and scale may be used that results in at least one full cage of vertices in each room-like space. This may be used to ensure a sufficient sampling of local-illumination variation inside each separated/distinct space in a scene. For human-scale scenes, a spacing of one to two meters may be used, just by way of example.

In the embodiment shown, the method 200 updates the irradiance field probes for each new frame associated with the scene. This updating allows the irradiance field probes to incorporate the effects of dynamic geometry and lighting within the scene, which enables truly dynamic high-fidelity global illumination. In particular, the method 200 may update the texels in probes to account for dynamic geometry and lighting variation, blending in their results over time in order to smoothly account for the effects of these dynamic changes on the final rendered result. Of course, intervals other than frame-by-frame may be employed to update the irradiance field probes based on changes to the scene. Similar to method 100, the method 200 may be performed by one or more (e.g. parallel) processing units.

As shown in decision 202, it is determined whether there is a new frame for the scene (e.g. to be rendered). As noted above, the updating, as described below, is prompted for each new frame for the scene. As an option, prior to proceeding to operation 204, a placement of each irradiance field probe may be iteratively adjusted as offsets from a 3D grid over static geometry of the scene. This option will be described in more detail below.

Responsive to determining there is a new frame for the scene, active irradiance field probes are selected, as shown in operation 204. An irradiance field probe may considered active when it is within a predefined distance of some geometry within the scene, but not inside the geometry or outside of the scene. Of course, other embodiments are contemplated in which all irradiance field probes are considered active, or a subset thereof based on other criteria.

Additionally, in operation 206, a plurality of primary rays are generated and traced from each of the active irradiance field probes. In one embodiment, for each of the m active probes, n spherical directions are uniformly sampled according to a stochastically-rotated Fibonacci spiral pattern. n rays are then spawned with these directions and a (shared) origin of the probe center. The rays are laid out across the m probes in a thread-coherent fashion, casting all of them in one batch. While the above description relates to a same number of rays per probe, other embodiments are contemplated in which a different number of rays per probe may be used. Further, in operation 208, geometry for surface hits are stored in a buffer having a plurality of surfels with explicit position and normals.

Still yet, in operation 210, intersected surfels are shaded with direct and indirect illumination. Shading the probe-intersected surfels may rely on lighting and probe data from the previous frame, which serves two purposes: first, this allows the cost of computing multiple indirect bounces over several frames to amortized; second, when combined with a blending approach utilized for updating the probes in operation 212 (described below), this allows a smooth transition between sharp geometric and radiometric discontinuities (over time).

In one embodiment, a unified shading model may be employed for both probe updates and final rendering. In one embodiment, global illumination may be computed in two contexts at runtime: first, when updating the shading on the mxn probe-sampled surfels, and, finally, when shading pixels from the camera for the final output image. Both of these contexts may use the same shading routine, composed of a direct illumination pass and an indirect lighting pass that leverages the probe data.

The details of the shading routines are described in more detail below, focusing on the subtle differences in its application during probe surfel updates. However, to summarize the differences in how shading queries are made during probe update and final rendering, the shading routines expect a shading position, normal, and viewing direction as input. For probe-traced surfel shading updates, the intersected surfel locations and normals are passed, as well as the direction from the surfel to the probe center, as input to the shading routine.

Finally, in operation 212, the active irradiance field probes are updated by blending in an updated shading, updated distance, and updated square distance for each of the intersected surfels. To this end, at each frame the method 20 may efficiently blend updated ray-traced illumination into the probe atlas generated in the method 100 of FIG. 1 in addition to interpolating probe depth information to adapt to changes in scene geometry.

In one embodiment, after surfel shading in operation 210, each of the m×n surfel points will have an updated shading value, and the sampled surfel distances (and squared distance) are also updated relative to their associated probe centers. The probe texels (associated to each surfel) are updated by alpha-blending in the new shading results at a rate of 1−α, where a is a hysteresis parameter that controls the rate at which updated shading overrides shading results from previous frames, as shown in Equation 1 below.

$$newIrradiance [ texelDir ] = lerp ( oldIrradiance [ texelDir ] , {\sum }_{ProbeRays} ( max ( 0 , texelDir \cdot rayDir ) * rayRadiance ) , hysteresis ) \qquad Equation 1$$

In one exemplary embodiment, a may be set between 0.85 and 0.98.

The filtered irradiance may be directly computed using a moment-based filtered shadow query, allowing avoidance of brute-force prefiltering of a (higher-resolution) incident radiance map. This smooth incident irradiance field may be used to compute diffuse indirect illumination (described below), and optionally a higher-frequency shading map for glossy and specular indirect shading may be maintained.

In one embodiment, the data and update computation may be performed in an order which promotes coherence in execution: probe texels operate in (near) lockstep to their neighbors, often operating on the same ray, blending in its result. This yields not only coherent memory fetches on the GPU, but also coherent compute. Irradiance and depth texels may be updated against a cosine lobe distribution, which will correct irradiance representation. In the case of the depth and depth-squared buffers, an additional depth sharpening may be employed, warping them according to a cosine-power lobe distribution. Texels weighted below a threshold (e.g. 0.001) in the cosine-power lobe distribution may not be updated. While the updated spherical irradiance distributions may be used to shade view-independent diffuse reflectance effects, they may also be updated to correctly account for any glossy/mirror view-dependent shading due to dynamic geometry and lighting in the environment.

To this end, once updated, the irradiance field probes may be utilized for shading the scene.

The following description provides details of further possible embodiments.

Shading with Irradiance Field Probes

Multi-bounce global illumination effects are computed with diffuse, glossy, and specular transport.

Direct Illumination

Direct illumination is computed from point and directional light sources using a deferred renderer with variance shadow mapping. Direct illumination can also be handled from extended area light sources using an indirect illumination pipeline: all one-bounce indirect lighting contributions (described below for Diffuse Indirect Illumination) compute one bounce of lighting seeded by the direct illumination in a scene. Multiple bounces of indirect illumination are instead seeded by the previous bounce of indirect lighting in the scene (described below for Multiple Bounces of Indirect Illumination). With this in mind, direct illumination can be computed from area lighting by seeding the indirect illumination shading routine with the area lighting emission profile in the scene (i.e. instead of the direct illumination profile).

With this approach, approximating direct illumination from area lights can be avoided, instead relying on the robustness of the probe-based shading technique to compute smooth area shadows and reflections.

Diffuse Indirect Illumination

Spherical incident irradiance distributions are computed at each probe, and a visibility-aware probe-weighting scheme queries diffuse irradiance from probes at shading points in the scene. Incident irradiance is modulated by spatially-varying diffuse surface albedo in order to compute one bounce of indirect outgoing diffuse radiance.

To compensate for the fact that the incident diffuse irradiance at a probe location does not account for local occlusion around a shading point, outgoing diffuse reflection may optionally be modulated by a screen-space ambient occlusion variant. Note, however, that this local occlusion may not be included when computing the surfel shading updates of method 200: the impact of omitting this term on secondary lighting (i.e. computed as the diffuse, glossy, or specular reflection of the surfel shading) is significantly less than on the lighting of directly-visible surfaces.

The indirect diffuse interpolation and sampling technique can increase robustness to dynamic geometry and lighting. Specifically, after computing the indices of the eight-probe cage that contains the shading point, interpolation weights can be computed for each irradiance probe from its position and direction (relative to the shading point), shown in FIG. 2B. With regard to the shading of a surfel X, each probe is sampled in the eight-probe cage using the surface normal n in world space. A backface-weight is applied to each probe P using dir, the direction from X to P. The mean distance stored for P is represented by r. To avoid sampling visibility near the visibility-function boundary (i.e. the surface), X is offset from the world-space position based on the surface normal and the camera-view vector.

The following weighting stages will have an effect on the final rendering, with each factor contributing to the elimination of artifacts:

1. Backface-cull probes that lie below the shading point's tangent plane, using a soft threshold that falls off smoothly as the dot product of the shading normal with the direction towards a probe approaches zero,

2. Apply a perceptually-based weighting to account for the human visual system's sensitivity to (relatively) low-intensity lighting in otherwise dark regions (i.e. light leaks): reduce the contribution of very low-irradiance values (i.e. less than 5% of the representable intensity range) according to a monotonically decreasing curve profile,

3. Apply mean- and variance-biased Chebyshev interpolants, as detailed in the variance shadow-mapping method, to the visibility queries in order to appropriately filter radiance queries,

4. Offset the shading point according to a bias proportional to the shading normal and the direction to the probes: this improves the robustness of the visibility-based interpolation weights by moving away from potential shadowed unshadowed discontinuities, and

5. Perform a standard trilinear interpolation based on the distance between the shading point and the probe centers, using the aforementioned weighting and biasing factors.

Each of these weighting terms may be appropriately bound using conservative epsilon tests in order to avoid numerical issues when normalizing the weights, e.g., when per-probe weights approach zero. Note that shading with standard irradiance probes results in significant lightleaking artifacts, whereas the final renderings using the field probes of the present descriptions agree much more closely with the path-traced ground truth. Further, additional weighting criterion described above allow embodiments to scale down to 16×16 medium-precision depth values without incurring any numerical issues.

Multiple Bounces of Global Illumination

Multiple bounces of indirect illumination may be computed recursively, across frames, seeding the radiance buffers with the previous bounce of light. This may lead to a time-lag artifact for indirect bounces that is most evident in static scenes viewed by a static camera, which is not noticeable when the view, lighting, and/or scene geometry is dynamic.

Second Order Glossy

Raytraced reflections are more realistic than screen-space reflections, but tracing rays for 2nd through nth order reflections is infeasible on most scenes. In one embodiment, reflections can be improved by extending probe data to shade rough primary glossy reflections and 2^{nd} through nth order glossy reflections, resulting in better image quality.

It is common practice in production path tracing to reduce noise by roughening surfaces (or otherwise truncating the BSDF (bidirectional scattering distribution function) evaluation) on deeper recursive bounces. However, using the irradiance probes for second order reflections may achieve the same result and avoid noise by taking advantage of a data structure already available. Note, however, that the probe data structure stores cosine-filtered irradiance—not the cosine-weighted integral of radiance over the hemisphere, which is the correct measure for reflectance. These two quantities are equivalent to a factor of 2π, but the units are different: radiance (Ws⁻¹m₋₂) versus irradiance (Wm⁻²).

Perception-Based Exponential Encoding

Large, abrupt lighting changes in a scene can lead to lag in the indirect illumination if the irradiance probes are slow to converge, as noted above. The lag is most noticeable in light-to-dark transitions for two reasons: 1) light where there should not be light is more salient than vice-versa, which makes convergence appear to slow as scenes transition from very light to very dark; and 2) assuming irradiance values on a 0-1 scale, smaller values produce less of a change in stored irradiance during alpha blending. To combat this, convergence can be accelerated by applying a perception-based exponential encoding to probe irradiance values. This encoding interpolates perceptually linearly during lighting changes—faster to light-to-dark convergence reads as a linear drop in brightness. In one exemplary embodiment, an exponent of 5.0f may be used (lower may not converge as fast, higher may not converge any faster). The exponent may be exaggerated to speed convergence for light to dark transitions. This perception-based encoding has the additional effect of reducing low frequency flicker due to fireflies—bright flashes in the diffuse global illumination caused by an update ray hitting a small, bright irradiance source.

Table 1 illustrates an exemplary pseudocode for employing perception-based exponential encoding.

```
TABLE 1
float irradianceGamma = 5.0f
// Probe [symbol]
vec3 irradiance = vec3(0);
for [symbol]  probes in surrouding cage:
  vec3 probeIrradiance = texture(irradianceTexture, texCoord) .rgb;
  // Decode the tone curve, but leave [symbol]  gamma = 2 curve ( [symbol] )
to approximate [symbol]  blending for the trilinear
  probeIrradiance = pow(probeIrradiance,
  vec3(irradianceGamma * [symbol] );
  irradiance += weight * probeIrradiance;
// Go back to linear irradiance
irradiance = square (irradiance);
return irradiance;
//////////////////////////////////////
// Probe Update
// Sum ray contributions
vec3 sumOfCosineWeightedRayContributions;
vec3 oldIrradiance;
float hysteresis;
vec3 newIrradiance = pow(sumOfCosineWeightedRayContributions,
invIrradianceGamma);
return lerp(newIrradiance, oldIrradiance, hysteresis); [symbol]
indicates data missing or illegible when filed
```

Fast Convergence Heuristics

Convergence may be further accelerated with new per-texel heuristic thresholds. A lower threshold may detect changes with magnitude above 25% of maximum value (for irradiance and visibility) and lower the hysteresis by 0.15f. A higher threshold may detect changes with magnitude above 80% and drop the hysteresis to 0.0f, assuming the distribution the probe is sampling has changed completely. The higher threshold may be active only for irradiance information.

Scene-dependent per-probe heuristics may also be implemented that adjust the hysteresis based on lighting or geometry changes. Thus, irradiance field probes may be updated based on changes to the scene by adjusting hysteresis based on a magnitude of lighting or geometry changes. The heuristics may include:

1. Large lighting change (e.g. abrupt time of day shift): reduce irradiance hysteresis by 50% for 10 frames.

2. Small lighting change (e.g. player-held flashlight turns on): reduce irradiance hysteresis by 15% for 4 frames.

3. Large object change (e.g. ceiling caves in): reduce irradiance hysteresis by 50% for 10 frames and visibility hysteresis by 50% for 7 frames.

For all the heuristics, low hysteresis may be avoided for visibility updates as much as possible to achieve the most stable result. In each of the scene dependent heuristics, hysteresis for all probes may be reduced.

Table 2 illustrates an exemplary pseudocode for providing fast convergence heuristics.

TABLE 2
// Probe Update
// Sum ray contributions
vec4 sumOfCosineWeightedRayContributions;
vec4 oldValue;
float irradianceHysteresis;
float visibilityHysteresis;
const float significantChangeThreshold = 0.25;
float newDistributionChangeThreshold = 0.8;
// Scale by the max distance for visibility
if (visibility) {
newDistributionChangeThreshold [symbol] = maxDistance;
} [symbol]
indicates data missing or illegible when filed

Note that temporal anti-aliasing (TAA) may apply its own hysteresis, so the base hysteresis can be lower if TAA is applied. But, if TAA is applied, the TAA hysteresis may be adjusted according to scene heuristics just like the probe hysteresis, or else it may always add 50 ms to convergence even on a dramatic lighting or object change.

Self-Shadow Bias

In one embodiment, a single self-shadow bias may be provided for the irradiance field probes. Previous irradiance probe schemes required scene-tuned biases for mean, variance, and chebyshev terms to avoid light leaks. Embodiments herein may unify these constants into a single self-shadow bias term and reduce its magnitude. The selfshadow bias may also be more robust and require less scene-specific tuning—a default value, automatically scaled proportional to the probe grid size may work for most scenes. Note that a higher self shadow bias may be used necessary at lower ray counts to account for the increased variance in the depth estimate.

Probe States

As noted above, only active irradiance field probes may be updated. This requires determining a state of each of the irradiance field probes during updating. For all but the most basic scene geometry, many probes in the uniform grid will not contribute to the final image. A robust set of probe states may be used to avoid tracing or updating from such probes to increase performance with the same visual result.

The probe states separate probes that should not update from probes that must, with an additional intermediate state to identify probes that have just appeared (either at scene initialization or with a moving volume) and adjust their hysteresis accordingly. The full set of states and associated transitions is shown in FIG. 2C. Active probes may include the Awake and Vigilent states.

Optimized Placement

To ensure the minimal number of inactive probes resulting from their inclusion in geometry, placement of the probes may be optimized. In particular, to further decrease leaking, probe update rays that hit backfaces may record a value of 0 for irradiance and shorten their depth values by 80%. To ensure the minimal number of probes are stuck in walls, probe positions may be updated using an iterative adjustment algorithm.

Probe visibility prevents light and shadow leaks from occluded probes, but leaves some probes in total occlusion such that they never contribute to shading. A simple, fast optimizer may be provided shifts probes around static geometry to maximize the number of useful probes and generate good viewpoints. Before probe state classification, the optimizer iteratively adjusts each probe through the closest backface it can see, then further adjusts probes away from close front-faces to maximize surface visibility. Probes may not be moved around dynamic geometry because this may cause instability—a stable result is preferable to an unstable result with lower error.

To correctly light dynamic objects, embodiments may leverage the fact that a uniformly sampled probe is an approximation of the full lightfield at its sample location. If a probe passes through a dynamic object, the backface heuristics (described above) will prevent shadow leaking. When the probe emerges, our hysteresis heuristics (described above) will quickly converge its value.

To preserve the indexing properties of the 3D grid, probes may never move more than 0:5f*probeSpacing during optimization.

The purpose of the optimizer is to increase probes that can contribute to the final image. In one embodiment, the probe position optimizer may run for 5 iterations during probe state classification, which may be enough for almost all probes to converge their locations. A limited number of iterations may be necessary to prevent probes from moving back and forth (infinitely) through tangent backfaces.

Table 3 illustrates exemplary pseudocode for optimized placement of probes.

```
TABLE 3
for each probe:
  backfaceCount = 0
  offset = 0
  for each ray:
    if (backface)
      backfaceCount++
  // More than 25% backface
  if (backfaceCount / RAYS_PER_PROBE > 0.25)
    closestBackfaceDirection = ray.Direction *
    closestBackfaceDistance
    scale = 2.0f
    while scale > 1.0f && offset >= maxOffset:
      offset = scalar * closestBackfaceDirection
      scalar −= 0.1f
  probePosition += offset
```

Off Probes

The constraints on probe movement imposed by the 3D grid indexing may make it impossible to move all probes out of walls. Embodiments can identify those probes that remain in static geometry and turn them “Off” (such that they are not traced or updated). As the optimizer only considers static geometry, probes that happen to spawn inside dynamic geometry may be unaffected, and will correct turn on when appropriate.

Probe Update States

Even probes that are outside static geometry may not be used for shading every frame: when no geometry is within probeSpacing of a probe, that probe's value may not be used. Embodiments may set these probes to “Asleep” and wake them up when a surface is about to use them for shading. Note that a close surface is the only time when probes may need to be “Awake”. Nearby lighting changes and camera proximity do not matter if the probe is not shading a surface (or about to shade a surface on the next frame). The same may be true for making probes “Asleep”: when the camera can't see a probe, it still needs to be “Awake” if it is shading a surface because it is propagating global illumination (with 2 through nth order visibility). Thus, probes that shade static geometry should always trace and update—these probes may be called “Vigilant”. Though probes near geometry must trace to propagate global illumination, the grid resolution need not be as high in regions that are far from the camera. The purpose of the multivolume cascades is to take advantage of this for performance without affecting final image quality (see below).

Embodiments may optimize both probe positions and probe states in a four step pass:

1. For all uninitialized probes, trace rays for 5 frames to determine optimal positioning and initial state. At the end of this pass, all previously uninitialized probes are “Newly Vigilant”, “Off”, or “Sleeping”.

2. Pass dynamic object array, extending AABBs by the self-shadow bias for a conservative estimate. Set all “Sleeping” probes inside the extended AABB of a dynamic object to “Newly Awake”.

3. Trace a large number of rays for “Newly Vigilant” and “Newly Awake” probes to converge them in a frame, setting hysteresis to 0. Set their states to “Vigilant” and “Awake” respectively.

4. Trace rays from “Vigilant” and “Awake” probes to update their values with the normal hysteresis value for the scene.

Though these passes may run for every frame, for the majority of frames only the final step will run because no probes will be uninitialized and no moving objects or the camera will set probes to “Newly Awake” (in the case of moving objects) or “Uninitialized” (in the case of camera motion with a camera locked volume).

Probe Sleeping Performance

By employing probe sleeping using the probe state scheme performance may be improved, as well as allowing increases in rays cast per probe for the same performance. Casting more rays per probe makes new probe values more stable—this allows for a lower global hysteresis, which in turn speeds convergence in the global illumination.

Probe Update

The probe texels may be updated by alpha blending in the new shading results at a rate of 1-α, where α is a hysteresis parameter that controls the rate at which updated shading overrides shading results from previous frames (see Equation 2 below). In one example, a may be set between 0:85-0:98.

$$newIrradiance [ texelDir ] = lerp ( oldIrradiance [ texelDir ] , {\sum }_{ProbeRays} ( max ( 0 , texelDir \cdot rayDir ) * rayRadiance ) , hysteresis ) \qquad Equation 2$$

Table 4 illustrates exemplary pseudocode for another embodiment of optimized placement of probes.

```
TABLE 4
for each uninitialized probe
  Trace rays (distance only, no shading)
  Position optimizer iteration
  if (still in wall):
    OFF
  if (frontfaceDistance < probeSpacing):
    NEWLY VIGILANT
  else
    SLEEPING
for all dynamic geo:
  Extend bounding boxes grid cell size + self shadow bias
  fall all SLEEPING probes:
    if (probe inside bounding box):
      NEWLY AWAKE
// Optionally converge proes in this frame...
for all NEWLY AWAKE and NEWLY VIGILANT probes:
  Trace rays to converge value
  NEWLY AWAKE -> AWAKE
  NEWLY VIGILANT -> VIGILANT
// ...or let them converge in the update pass.
for all VIGILANT or AWAKE probes:
  Trace rays and update value.
```

Each probe texel computation may be independent and so can be updated in parallel on the GPU. Because this is fundamentally a general purpose GPU (GPGPU) compute operation, it can be optimized with GPU compute best practices. Modern GPU architectures dispatch groups of 32 threads (warps) to cover user specified compute grid dimensions. All threads in a warp will execute the same code in parallel, so ensuring that threads do not take different control paths in the code (coherent execution) is vital for performance.

Embodiments can achieve a 3× performance improvement in the update pass over a pixel shader approach with careful indexing over thread blocks consisting of an integer number of warps. All warp execution is fully coherent. In addition, incoming ray data can be stored in shared memory buffers so that all threads can read it in parallel when computing a new probe texel value.

With regard to probe resolution on image quality and performance, probe resolution in one embodiment may be selected at 8×8 irradiance, 16×16 visibility for a combination of bandwidth, memory footprint, fast convolution, efficient index computation, and most important: mapping to SIMD instructions (thread lanes on a GPU) for peak occupancy. At powers of two, a probe can be updated exactly by an integer number of 32 thread warps for maximum possible occupation and coherence. At even number resolutions (multiples of two), high thread coherence can still be achieved. Arbitrary resolution values offer the highest flexibility at the cost of efficiency.

FIG. 2D shows details of the compute shader indexing, including an example octahedral probe encoding to illustrate border-texel copy for correct bilinear interpolation in hardware. The optimized compute shader may be included alongside another update shader, one embodiment.

Inline Shading

Previous probe schemes required an extra shader pass to gather the indirect contribution over the frame. Embodiments above present a simpler framework that optimizes the global illumination gather step to directly sample the probe data structure during shading, yielding reduced bandwidth requirements.

Camera Tracking Windows

Conceptually, a probe grid covers all explorable space in the scene. In practice, embodiments may not be able to afford to update and trace a level-sized high resolution probe grid, most of which would be wasted effort updating probes that are too densely packed in regions too far from the camera. To get high probe resolution where it is most necessary, embodiments may implement a dense, camera tracking (3D) window of probes. The window begins centered on the camera. As the camera moves, if it moves further than probeSpacing from the center (along any axis), a new plane of probes spawns in front of it (relative to its direction of motion) and the plane furthest behind it disappears (again relative to its direction of motion). Embodiments may implement this behavior using a 3D fixed-length circular buffer. When a new probe plane appears and is initialized, its new values are written to the memory of the plane in the last row behind the camera: the probes “leapfrog” over the camera in discrete steps. A discretely stepping probe volume necessitates careful interpolation between multiple probe volumes—one strategy for which is described below.

FIG. 2E illustrates the volume indexing with phase offset in 2D. The row of probes that moves is colored in gray. When the camera passes the center bounding threshold moving in the +X direction, the leftmost row of probes leapfrogs to the +X face of the volume. The newly computed grid index is shown in gray. The corresponding phase offset change is shown on the right.

Multiple Probe Volumes

Multiple probe volumes at differing resolutions can be used to efficiently implement progressively decreasing grid resolutions that cascade out from the camera, thus saving performance without effecting image quality. Additional high resolution volumes can also be used to efficiently cover hero assets with complex geometry that require higher resolution global illumination.

FIG. 2F illustrates probe initialization and motion around a camera tracked volume.

FIG. 2G illustrates Blending between multiple volumes.

Embodiments blend between volumes by linearly falling off from 1.0-0.0 at the last grid cell (starting at the second-to-last plane of probes) along each axis of the 3D grid. In the deferred shader, a weight is computed for each volume starting from most to least dense. This may also be the sampling order because the most dense volume will have the best approximation of the local lightfield. Volume weights are accumulated at each volume sample. After the weight total reaches 1.0, further volumes are skipped. Weighted volume blending yields smooth transitions for static volumes, but can cause popping in the global illumination when applied to camera locked volumes. This happens because when a volume leapfrogs in front of the camera, some points can go from being fully shaded by a sparse cascade to being heavily shaded by the camera cascade. To address this, when computing blending weights for camera locked volumes embodiments may tighten the transition region by one grid cell (along each axis) then center it on the camera. When a new plane of probes leapfrogs to the front of a volume, points that are newly within that volume will not immediately be shaded by it. Instead, those points will gradually transition between volumes as the camera moves towards them.

In one example, all probe volumes may be passed to the deferred shader, which then per-pixel iterates through them to figure out which ones contain the point being shaded. This may provide the highest flexibility in tweaking the blending algorithm to evaluate image quality. For a production implementation, for the deferred shading light loop issue (considering the volumes as lights) are available:

1. Do the full brute force light loop—for fewer than 10 volumes, the point-in-OBB test to determine which volumes contain the shaded point is fast to evaluate.

2. Make one deferred pass per volume, rasterizing the volume's bounds to find the covered pixels.

3. Make a spatial data structure (e.g., octtree, BVH) over the volumes and then traverse that at runtime in the pixel shader to find which volumes the pixel is in. This method requires more bookeeping and potentially costly data-dependent fetches.

4. Use tiles set up on the CPU or with a GPU pass to conservatively approximate one of the previous methods.

For the pure cascaded method, these optimizations may not be necessary because volumes are axis-aligned in world space and nested in a regular pattern.

Conclusion

The above embodiments present an approach for updating and interpolating the irradiance field, as represented in dynamic diffuse global-illumination probes, in the presence of dynamic scene geometry and lighting, robustly treating temporal occlusion and lighting variation.

The embodiments do not suffer from light- or shadow-leaking artifacts, suppressing aliasing due to undersampling. The embodiments can compute accurate diffuse, glossy, and specular global-illumination effects in arbitrarily dynamic scenes at high performance. This is due, in part, to an efficient data-packed probe layout that enables ray and shading computation to be dispatched in a coherent manner across probes.

The indirect diffuse shading described above relies on a fundamental assumption about the spatial and angular relationship of radiance in a scene: here, it is assumed that the incident light at a shade point is similar to the incident light at the probes that surround it, if the probes and the point are mutually visible. However, any error induced by this assumption increases as probe density decreases.

The following description relates to embodiments of a parallel processing architecture that may be used to provide the probe-based dynamic global illumination described above.

Parallel Processing Architecture

FIG. 3 illustrates a parallel processing unit (PPU) 300, in accordance with an embodiment. In an embodiment, the PPU 300 is a multi-threaded processor that is implemented on one or more integrated circuit devices. The PPU 300 is a latency hiding architecture designed to process many threads in parallel. A thread (e.g., a thread of execution) is an instantiation of a set of instructions configured to be executed by the PPU 300. In an embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 300 may be configured to accelerate thousands of High Performance Computing (HPC), data center, and machine learning applications. The PPU 300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the PPU 300 includes an Input/Output (I/O) unit 305, a front end unit 315, a scheduler unit 320, a work distribution unit 325, a hub 330, a crossbar (Xbar) 370, one or more general processing clusters (GPCs) 350, and one or more memory partition units 380. The PPU 300 may be connected to a host processor or other PPUs 300 via one or more high-speed NVLink 310 interconnect. The PPU 300 may be connected to a host processor or other peripheral devices via an interconnect 302. The PPU 300 may also be connected to a local memory comprising a number of memory devices 304. In an embodiment, the local memory may comprise a number of dynamic random access memory (DRAM) devices. The DRAM devices may be configured as a high-bandwidth memory (HBM) subsystem, with multiple DRAM dies stacked within each device.

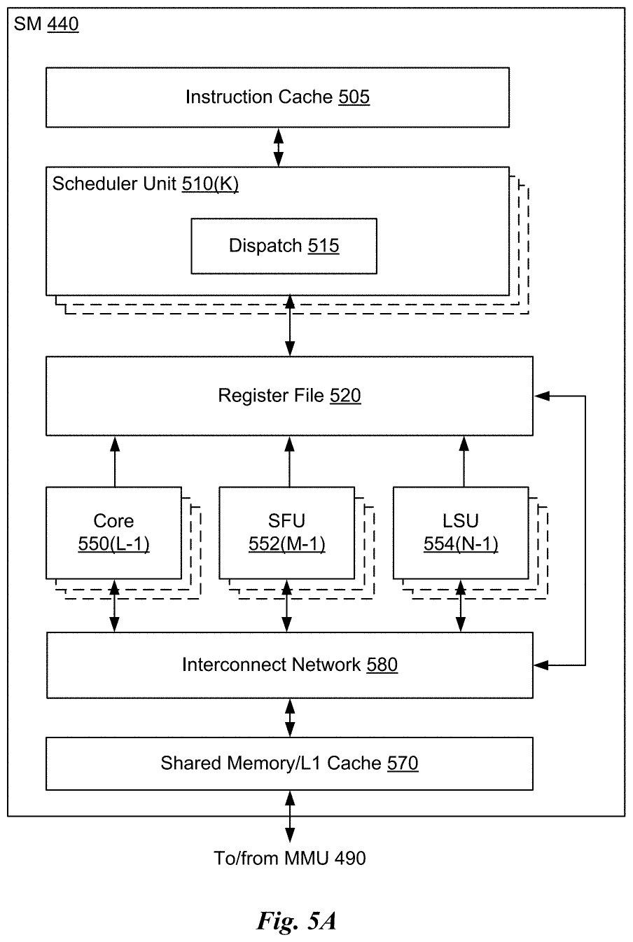

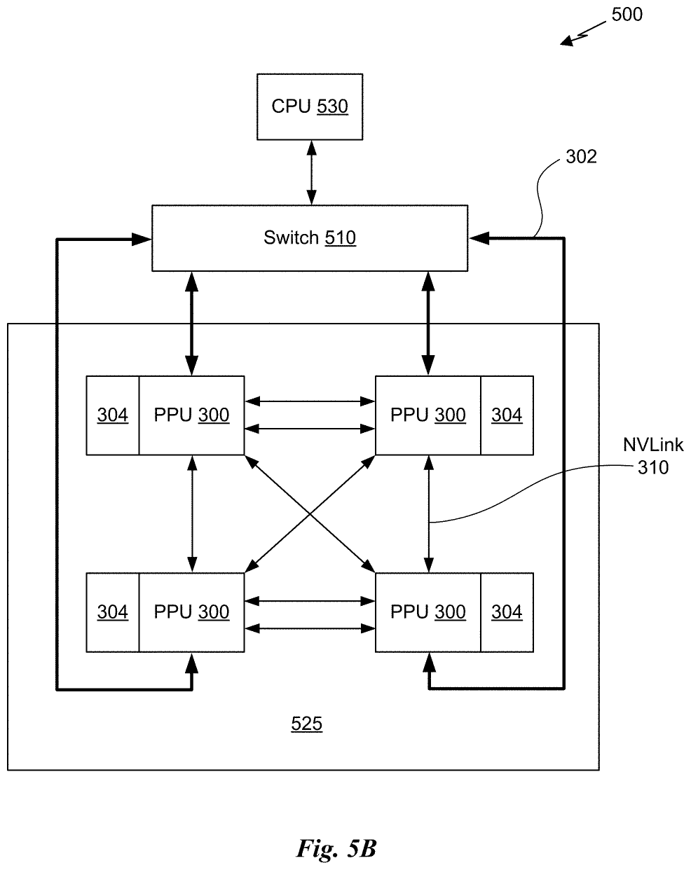

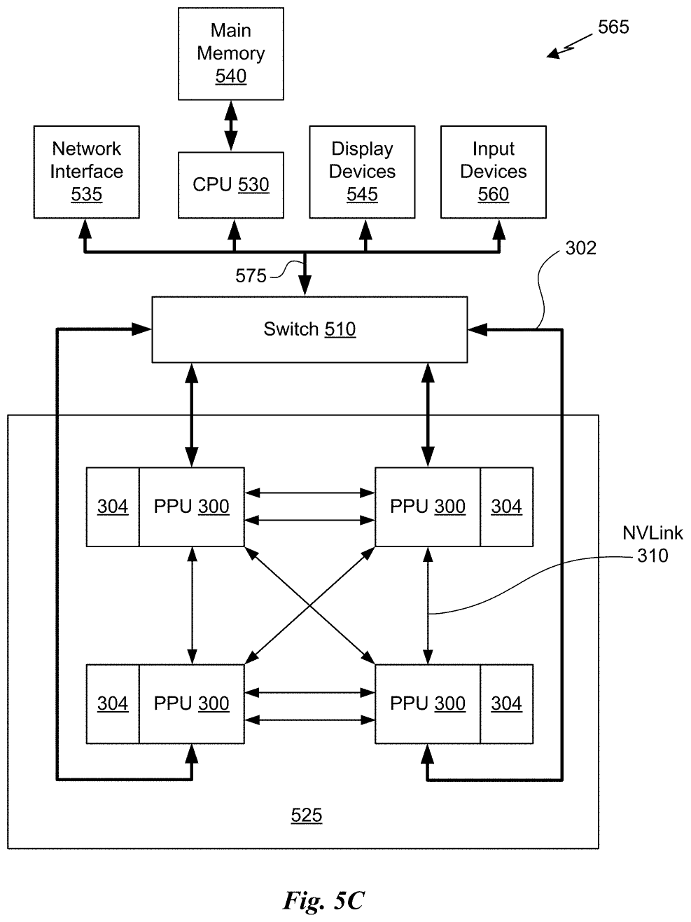

The NVLink 310 interconnect enables systems to scale and include one or more PPUs 300 combined with one or more CPUs, supports cache coherence between the PPUs 300 and CPUs, and CPU mastering. Data and/or commands may be transmitted by the NVLink 310 through the hub 330 to/from other units of the PPU 300 such as one or more copy engines, a video encoder, a video decoder, a power management unit, etc. (not explicitly shown). The NVLink 310 is described in more detail in conjunction with FIG. 5B.

The I/O unit 305 is configured to transmit and receive communications (e.g., commands, data, etc.) from a host processor (not shown) over the interconnect 302. The I/O unit 305 may communicate with the host processor directly via the interconnect 302 or through one or more intermediate devices such as a memory bridge. In an embodiment, the I/O unit 305 may communicate with one or more other processors, such as one or more the PPUs 300 via the interconnect 302. In an embodiment, the I/O unit 305 implements a Peripheral Component Interconnect Express (PCIe) interface for communications over a PCIe bus and the interconnect 302 is a PCIe bus. In alternative embodiments, the I/O unit 305 may implement other types of well-known interfaces for communicating with external devices.

The I/O unit 305 decodes packets received via the interconnect 302. In an embodiment, the packets represent commands configured to cause the PPU 300 to perform various operations. The I/O unit 305 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the I/O unit 305 is configured to route communications between and among the various logical units of the PPU 300.

In an embodiment, a program executed by the host processor encodes a command stream in a buffer that provides workloads to the PPU 300 for processing. A workload may comprise several instructions and data to be processed by those instructions. The buffer is a region in a memory that is accessible (e.g., read/write) by both the host processor and the PPU 300. For example, the I/O unit 305 may be configured to access the buffer in a system memory connected to the interconnect 302 via memory requests transmitted over the interconnect 302. In an embodiment, the host processor writes the command stream to the buffer and then transmits a pointer to the start of the command stream to the PPU 300. The front end unit 315 receives pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In an embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 may also be connected to the XBar 370 via the hub 330.

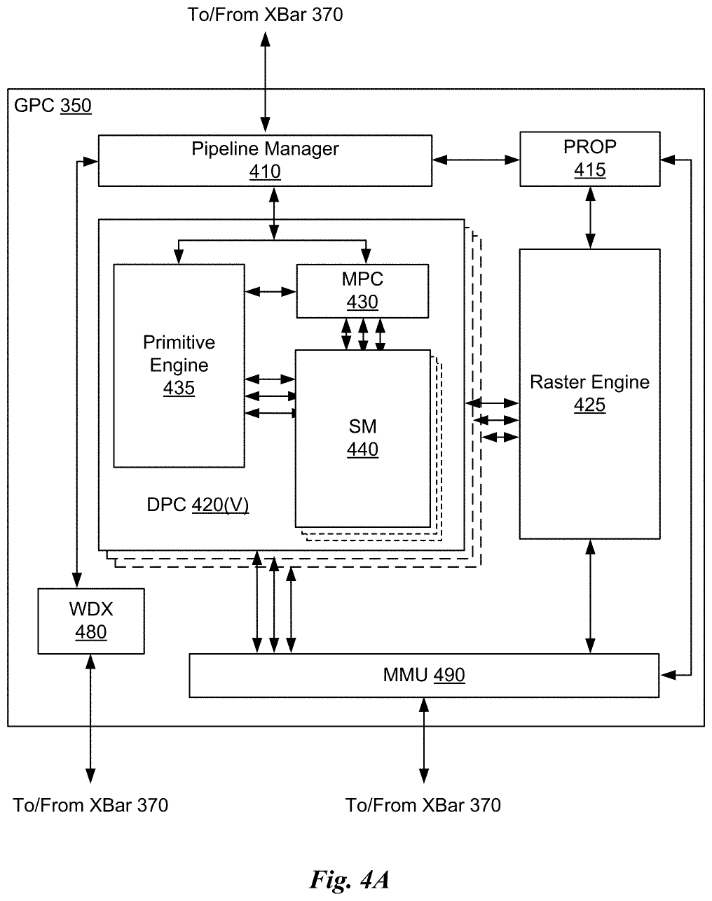

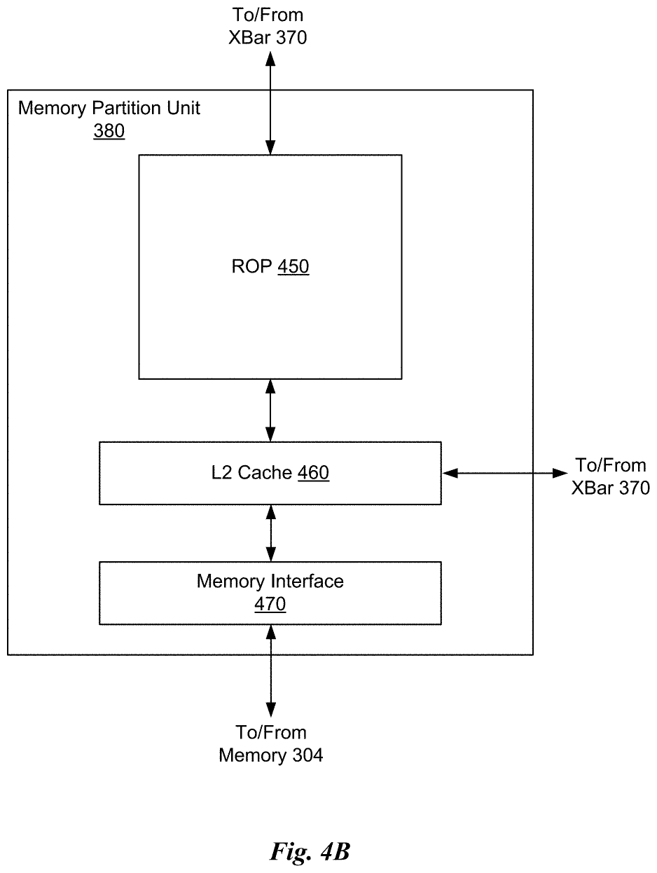

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the memory partition units 380, which implement a memory interface for reading and writing data to/from the memory 304. The results can be transmitted to another PPU 304 or CPU via the NVLink 310. In an embodiment, the PPU 300 includes a number U of memory partition units 380 that is equal to the number of separate and distinct memory devices 304 coupled to the PPU 300. A memory partition unit 380 will be described in more detail below in conjunction with FIG. 4B.

In an embodiment, a host processor executes a driver kernel that implements an application programming interface (API) that enables one or more applications executing on the host processor to schedule operations for execution on the PPU 300. In an embodiment, multiple compute applications are simultaneously executed by the PPU 300 and the PPU 300 provides isolation, quality of service (QoS), and independent address spaces for the multiple compute applications. An application may generate instructions (e.g., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5A.

FIG. 4A illustrates a GPC 350 of the PPU 300 of FIG. 3, in accordance with an embodiment. As shown in FIG. 4A, each GPC 350 includes a number of hardware units for processing tasks. In an embodiment, each GPC 350 includes a pipeline manager 410, a pre-raster operations unit (PROP) 415, a raster engine 425, a work distribution crossbar (WDX) 480, a memory management unit (MMU) 490, and one or more Data Processing Clusters (DPCs) 420. It will be appreciated that the GPC 350 of FIG. 4A may include other hardware units in lieu of or in addition to the units shown in FIG. 4A.

In an embodiment, the operation of the GPC 350 is controlled by the pipeline manager 410. The pipeline manager 410 manages the configuration of the one or more DPCs 420 for processing tasks allocated to the GPC 350. In an embodiment, the pipeline manager 410 may configure at least one of the one or more DPCs 420 to implement at least a portion of a graphics rendering pipeline. For example, a DPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the DPCs 420 for processing by the primitive engine 435 or the SM 440. In an embodiment, the pipeline manager 410 may configure at least one of the one or more DPCs 420 to implement a neural network model and/or a computing pipeline.

The PROP unit 415 is configured to route data generated by the raster engine 425 and the DPCs 420 to a Raster Operations (ROP) unit, described in more detail in conjunction with FIG. 4B. The PROP unit 415 may also be configured to perform optimizations for color blending, organize pixel data, perform address translations, and the like.

The raster engine 425 includes a number of fixed function hardware units configured to perform various raster operations. In an embodiment, the raster engine 425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 425 comprises fragments to be processed, for example, by a fragment shader implemented within a DPC 420.

Each DPC 420 included in the GPC 350 includes an M-Pipe Controller (MPC) 430, a primitive engine 435, and one or more SMs 440. The MPC 430 controls the operation of the DPC 420, routing packets received from the pipeline manager 410 to the appropriate units in the DPC 420. For example, packets associated with a vertex may be routed to the primitive engine 435, which is configured to fetch vertex attributes associated with the vertex from the memory 304. In contrast, packets associated with a shader program may be transmitted to the SM 440.

The SM 440 comprises a programmable streaming processor that is configured to process tasks represented by a number of threads. Each SM 440 is multi-threaded and configured to execute a plurality of threads (e.g., 32 threads) from a particular group of threads concurrently. In an embodiment, the SM 440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 440 will be described in more detail below in conjunction with FIG. 5A.

The MMU 490 provides an interface between the GPC 350 and the memory partition unit 380. The MMU 490 may provide translation of virtual addresses into physical addresses, memory protection, and arbitration of memory requests. In an embodiment, the MMU 490 provides one or more translation lookaside buffers (TLBs) for performing translation of virtual addresses into physical addresses in the memory 304.

FIG. 4B illustrates a memory partition unit 380 of the PPU 300 of FIG. 3, in accordance with an embodiment. As shown in FIG. 4B, the memory partition unit 380 includes a Raster Operations (ROP) unit 450, a level two (L2) cache 460, and a memory interface 470. The memory interface 470 is coupled to the memory 304. Memory interface 470 may implement 32, 64, 128, 1024-bit data buses, or the like, for high-speed data transfer. In an embodiment, the PPU 300 incorporates U memory interfaces 470, one memory interface 470 per pair of memory partition units 380, where each pair of memory partition units 380 is connected to a corresponding memory device 304. For example, PPU 300 may be connected to up to Y memory devices 304, such as high bandwidth memory stacks or graphics double-data-rate, version 5, synchronous dynamic random access memory, or other types of persistent storage.

In an embodiment, the memory interface 470 implements an HBM2 memory interface and Y equals half U. In an embodiment, the HBM2 memory stacks are located on the same physical package as the PPU 300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 300 process very large datasets and/or run applications for extended periods.

In an embodiment, the PPU 300 implements a multi-level memory hierarchy. In an embodiment, the memory partition unit 380 supports a unified memory to provide a single unified virtual address space for CPU and PPU 300 memory, enabling data sharing between virtual memory systems. In an embodiment the frequency of accesses by a PPU 300 to memory located on other processors is traced to ensure that memory pages are moved to the physical memory of the PPU 300 that is accessing the pages more frequently. In an embodiment, the NVLink 310 supports address translation services allowing the PPU 300 to directly access a CPU's page tables and providing full access to CPU memory by the PPU 300.

In an embodiment, copy engines transfer data between multiple PPUs 300 or between PPUs 300 and CPUs. The copy engines can generate page faults for addresses that are not mapped into the page tables. The memory partition unit 380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 304 or other system memory may be fetched by the memory partition unit 380 and stored in the L2 cache 460, which is located on-chip and is shared between the various GPCs 350. As shown, each memory partition unit 380 includes a portion of the L2 cache 460 associated with a corresponding memory device 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 performs graphics raster operations related to pixel color, such as color compression, pixel blending, and the like. The ROP unit 450 also implements depth testing in conjunction with the raster engine 425, receiving a depth for a sample location associated with a pixel fragment from the culling engine of the raster engine 425. The depth is tested against a corresponding depth in a depth buffer for a sample location associated with the fragment. If the fragment passes the depth test for the sample location, then the ROP unit 450 updates the depth buffer and transmits a result of the depth test to the raster engine 425. It will be appreciated that the number of memory partition units 380 may be different than the number of GPCs 350 and, therefore, each ROP unit 450 may be coupled to each of the GPCs 350. The ROP unit 450 tracks packets received from the different GPCs 350 and determines which GPC 350 that a result generated by the ROP unit 450 is routed to through the Xbar 370. Although the ROP unit 450 is included within the memory partition unit 380 in FIG. 4B, in other embodiment, the ROP unit 450 may be outside of the memory partition unit 380. For example, the ROP unit 450 may reside in the GPC 350 or another unit.

FIG. 5A illustrates the streaming multi-processor 440 of FIG. 4A, in accordance with an embodiment. As shown in FIG. 5A, the SM 440 includes an instruction cache 505, one or more scheduler units 510, a register file 520, one or more processing cores 550, one or more special function units (SFUs) 552, one or more load/store units (LSUs) 554, an interconnect network 580, a shared memory/L1 cache 570.

As described above, the work distribution unit 325 dispatches tasks for execution on the GPCs 350 of the PPU 300. The tasks are allocated to a particular DPC 420 within a GPC 350 and, if the task is associated with a shader program, the task may be allocated to an SM 440. The scheduler unit 510 receives the tasks from the work distribution unit 325 and manages instruction scheduling for one or more thread blocks assigned to the SM 440. The scheduler unit 510 schedules thread blocks for execution as warps of parallel threads, where each thread block is allocated at least one warp. In an embodiment, each warp executes 32 threads. The scheduler unit 510 may manage a plurality of different thread blocks, allocating the warps to the different thread blocks and then dispatching instructions from the plurality of different cooperative groups to the various functional units (e.g., cores 550, SFUs 552, and LSUs 554) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 515 is configured to transmit instructions to one or more of the functional units. In the embodiment, the scheduler unit 510 includes two dispatch units 515 that enable two different instructions from the same warp to be dispatched during each clock cycle. In alternative embodiments, each scheduler unit 510 may include a single dispatch unit 515 or additional dispatch units 515.

Each SM 440 includes a register file 520 that provides a set of registers for the functional units of the SM 440. In an embodiment, the register file 520 is divided between each of the functional units such that each functional unit is allocated a dedicated portion of the register file 520. In another embodiment, the register file 520 is divided between the different warps being executed by the SM 440. The register file 520 provides temporary storage for operands connected to the data paths of the functional units.

Each SM 440 comprises L processing cores 550. In an embodiment, the SM 440 includes a large number (e.g., 128, etc.) of distinct processing cores 550. Each core 550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 550 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 550. In particular, the tensor cores are configured to perform deep learning matrix arithmetic, such as convolution operations for neural network training and inferencing. In an embodiment, each tensor core operates on a 4x4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 440 also comprises M SFUs 552 that perform special functions (e.g., attribute evaluation, reciprocal square root, and the like). In an embodiment, the SFUs 552 may include a tree traversal unit configured to traverse a hierarchical tree data structure. In an embodiment, the SFUs 552 may include texture unit configured to perform texture map filtering operations. In an embodiment, the texture units are configured to load texture maps (e.g., a 2D array of texels) from the memory 304 and sample the texture maps to produce sampled texture values for use in shader programs executed by the SM 440. In an embodiment, the texture maps are stored in the shared memory/L1 cache 470. The texture units implement texture operations such as filtering operations using mip-maps (e.g., texture maps of varying levels of detail). In an embodiment, each SM 340 includes two texture units.

Each SM 440 also comprises N LSUs 554 that implement load and store operations between the shared memory/L1 cache 570 and the register file 520. Each SM 440 includes an interconnect network 580 that connects each of the functional units to the register file 520 and the LSU 554 to the register file 520, shared memory/ L1 cache 570. In an embodiment, the interconnect network 580 is a crossbar that can be configured to connect any of the functional units to any of the registers in the register file 520 and connect the LSUs 554 to the register file and memory locations in shared memory/L1 cache 570.

The shared memory/L1 cache 570 is an array of on-chip memory that allows for data storage and communication between the SM 440 and the primitive engine 435 and between threads in the SM 440. In an embodiment, the shared memory/L1 cache 570 comprises 128 KB of storage capacity and is in the path from the SM 440 to the memory partition unit 380. The shared memory/L1 cache 570 can be used to cache reads and writes. One or more of the shared memory/L1 cache 570, L2 cache 460, and memory 304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 570 enables the shared memory/L1 cache 570 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 325 assigns and distributes blocks of threads directly to the DPCs 420. The threads in a block execute the same program, using a unique thread ID in the calculation to ensure each thread generates unique results, using the SM 440 to execute the program and perform calculations, shared memory/L1 cache 570 to communicate between threads, and the LSU 554 to read and write global memory through the shared memory/L1 cache 570 and the memory partition unit 380. When configured for general purpose parallel computation, the SM 440 can also write commands that the scheduler unit 320 can use to launch new work on the DPCs 420.

The PPU 300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 300 is embodied on a single semiconductor substrate. In another embodiment, the PPU 300 is included in a system-on-a-chip (SoC) along with one or more other devices such as additional PPUs 300, the memory 304, a reduced instruction set computer (RISC) CPU, a memory management unit (MMU), a digital-to-analog converter (DAC), and the like.

In an embodiment, the PPU 300 may be included on a graphics card that includes one or more memory devices 304. The graphics card may be configured to interface with a PCIe slot on a motherboard of a desktop computer. In yet another embodiment, the PPU 300 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5B is a conceptual diagram of a processing system 500 implemented using the PPU 300 of FIG. 3, in accordance with an embodiment. The exemplary system 565 may be configured to implement the method 100 shown in FIG. 1. The processing system 500 includes a CPU 530, switch 510, and multiple PPUs 300 each and respective memories 304. The NVLink 310 provides high-speed communication links between each of the PPUs 300. Although a particular number of NVLink 310 and interconnect 302 connections are illustrated in FIG. 5B, the number of connections to each PPU 300 and the CPU 530 may vary. The switch 510 interfaces between the interconnect 302 and the CPU 530. The PPUs 300, memories 304, and NVLinks 310 may be situated on a single semiconductor platform to form a parallel processing module 525. In an embodiment, the switch 510 supports two or more protocols to interface between various different connections and/or links.

In another embodiment (not shown), the NVLink 310 provides one or more high-speed communication links between each of the PPUs 300 and the CPU 530 and the switch 510 interfaces between the interconnect 302 and each of the PPUs 300. The PPUs 300, memories 304, and interconnect 302 may be situated on a single semiconductor platform to form a parallel processing module 525. In yet another embodiment (not shown), the interconnect 302 provides one or more communication links between each of the PPUs 300 and the CPU 530 and the switch 510 interfaces between each of the PPUs 300 using the NVLink 310 to provide one or more high-speed communication links between the PPUs 300. In another embodiment (not shown), the NVLink 310 provides one or more high-speed communication links between the PPUs 300 and the CPU 530 through the switch 510. In yet another embodiment (not shown), the interconnect 302 provides one or more communication links between each of the PPUs 300 directly. One or more of the NVLink 310 high-speed communication links may be implemented as a physical NVLink interconnect or either an on-chip or on-die interconnect using the same protocol as the NVLink 310.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 300 and/or memories 304 may be packaged devices. In an embodiment, the CPU 530, switch 510, and the parallel processing module 525 are situated on a single semiconductor platform.

In an embodiment, the signaling rate of each NVLink 310 is 20 to 25 Gigabits/second and each PPU 300 includes six NVLink 310 interfaces (as shown in FIG. 5B, five NVLink 310 interfaces are included for each PPU 300). Each NVLink 310 provides a data transfer rate of 25 Gigabytes/second in each direction, with six links providing 300 Gigabytes/second. The NVLinks 310 can be used exclusively for PPU-to-PPU communication as shown in FIG. 5B, or some combination of PPU-to-PPU and PPU-to-CPU, when the CPU 530 also includes one or more NVLink 310 interfaces.

In an embodiment, the NVLink 310 allows direct load/store/atomic access from the CPU 530 to each PPU's 300 memory 304. In an embodiment, the NVLink 310 supports coherency operations, allowing data read from the memories 304 to be stored in the cache hierarchy of the CPU 530, reducing cache access latency for the CPU 530. In an embodiment, the NVLink 310 includes support for Address Translation Services (ATS), allowing the PPU 300 to directly access page tables within the CPU 530. One or more of the NVLinks 310 may also be configured to operate in a low-power mode.

FIG. 5C illustrates an exemplary system 565 in which the various architecture and/or functionality of the various previous embodiments may be implemented. The exemplary system 565 may be configured to implement the method 100 shown in FIG. 1.

As shown, a system 565 is provided including at least one central processing unit 530 that is connected to a communication bus 575. The communication bus 575 may be implemented using any suitable protocol, such as PCI (Peripheral Component Interconnect), PCI-Express, AGP (Accelerated Graphics Port), HyperTransport, or any other bus or point-to-point communication protocol(s). The system 565 also includes a main memory 540. Control logic (software) and data are stored in the main memory 540 which may take the form of random access memory (RAM).

The system 565 also includes input devices 560, the parallel processing system 525, and display devices 545, e.g. a conventional CRT (cathode ray tube), LCD (liquid crystal display), LED (light emitting diode), plasma display or the like. User input may be received from the input devices 560, e.g., keyboard, mouse, touchpad, microphone, and the like. Each of the foregoing modules and/or devices may even be situated on a single semiconductor platform to form the system 565. Alternately, the various modules may also be situated separately or in various combinations of semiconductor platforms per the desires of the user.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 540 and/or the secondary storage. Such computer programs, when executed, enable the system 565 to perform various functions. The memory 540, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 565 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 300 comprises a graphics processing unit (GPU). The PPU 300 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 300 can be configured to process the graphics primitives to generate a frame buffer (e.g., pixel data for each of the pixels of the display).

An application writes model data for a scene (e.g., a collection of vertices and attributes) to a memory such as a system memory or memory 304. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 440 of the PPU 300 including one or more of a vertex shader, hull shader, domain shader, geometry shader, and a pixel shader. For example, one or more of the SMs 440 may be configured to execute a vertex shader program that processes a number of vertices defined by the model data. In an embodiment, the different SMs 440 may be configured to execute different shader programs concurrently. For example, a first subset of SMs 440 may be configured to execute a vertex shader program while a second subset of SMs 440 may be configured to execute a pixel shader program. The first subset of SMs 440 processes vertex data to produce processed vertex data and writes the processed vertex data to the L2 cache 460 and/or the memory 304. After the processed vertex data is rasterized (e.g., transformed from three-dimensional data into two-dimensional data in screen space) to produce fragment data, the second subset of SMs 440 executes a pixel shader to produce processed fragment data, which is then blended with other processed fragment data and written to the frame buffer in memory 304. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

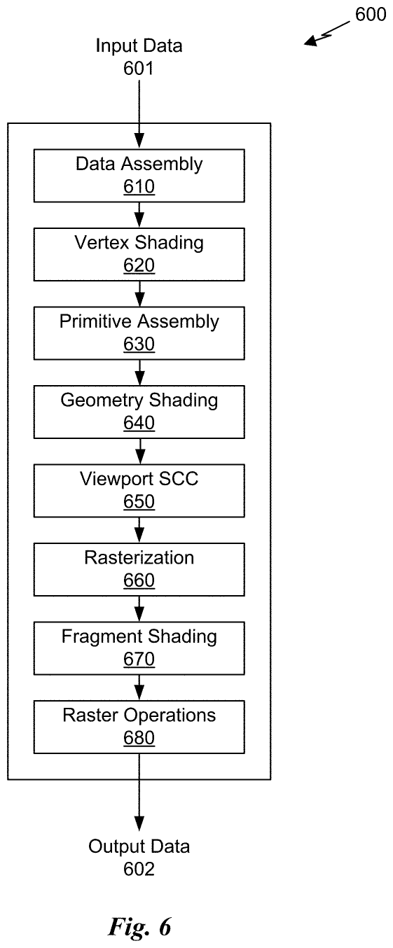

FIG. 6 is a conceptual diagram of a graphics processing pipeline 600 implemented by the PPU 300 of FIG. 3, in accordance with an embodiment. The graphics processing pipeline 600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 600 receives input data 601 that is transmitted from one stage to the next stage of the graphics processing pipeline 600 to generate output data 602. In an embodiment, the graphics processing pipeline 600 may represent a graphics processing pipeline defined by the OpenGL® API. As an option, the graphics processing pipeline 600 may be implemented in the context of the functionality and architecture of the previous Figures and/or any subsequent Figure(s).

As shown in FIG. 6, the graphics processing pipeline 600 comprises a pipeline architecture that includes a number of stages. The stages include, but are not limited to, a data assembly stage 610, a vertex shading stage 620, a primitive assembly stage 630, a geometry shading stage 640, a viewport scale, cull, and clip (VSCC) stage 650, a rasterization stage 660, a fragment shading stage 670, and a raster operations stage 680. In an embodiment, the input data 601 comprises commands that configure the processing units to implement the stages of the graphics processing pipeline 600 and geometric primitives (e.g., points, lines, triangles, quads, triangle strips or fans, etc.) to be processed by the stages. The output data 602 may comprise pixel data (e.g., color data) that is copied into a frame buffer or other type of surface data structure in a memory.

The data assembly stage 610 receives the input data 601 that specifies vertex data for high-order surfaces, primitives, or the like. The data assembly stage 610 collects the vertex data in a temporary storage or queue, such as by receiving a command from the host processor that includes a pointer to a buffer in memory and reading the vertex data from the buffer. The vertex data is then transmitted to the vertex shading stage 620 for processing.

The vertex shading stage 620 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 620 may manipulate individual vertex attributes such as position, color, texture coordinates, and the like. In other words, the vertex shading stage 620 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 620 generates transformed vertex data that is transmitted to the primitive assembly stage 630.

The primitive assembly stage 630 collects vertices output by the vertex shading stage 620 and groups the vertices into geometric primitives for processing by the geometry shading stage 640. For example, the primitive assembly stage 630 may be configured to group every three consecutive vertices as a geometric primitive (e.g., a triangle) for transmission to the geometry shading stage 640. In some embodiments, specific vertices may be reused for consecutive geometric primitives (e.g., two consecutive triangles in a triangle strip may share two vertices). The primitive assembly stage 630 transmits geometric primitives (e.g., a collection of associated vertices) to the geometry shading stage 640.

The geometry shading stage 640 processes geometric primitives by performing a set of operations (e.g., a geometry shader or program) on the geometric primitives. Tessellation operations may generate one or more geometric primitives from each geometric primitive. In other words, the geometry shading stage 640 may subdivide each geometric primitive into a finer mesh of two or more geometric primitives for processing by the rest of the graphics processing pipeline 600. The geometry shading stage 640 transmits geometric primitives to the viewport SCC stage 650.

In an embodiment, the graphics processing pipeline 600 may operate within a streaming multiprocessor and the vertex shading stage 620, the primitive assembly stage 630, the geometry shading stage 640, the fragment shading stage 670, and/or hardware/software associated therewith, may sequentially perform processing operations. Once the sequential processing operations are complete, in an embodiment, the viewport SCC stage 650 may utilize the data. In an embodiment, primitive data processed by one or more of the stages in the graphics processing pipeline 600 may be written to a cache (e.g. L1 cache, a vertex cache, etc.). In this case, in an embodiment, the viewport SCC stage 650 may access the data in the cache. In an embodiment, the viewport SCC stage 650 and the rasterization stage 660 are implemented as fixed function circuitry.

The viewport SCC stage 650 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 660.

The rasterization stage 660 converts the 3D geometric primitives into 2D fragments (e.g. capable of being utilized for display, etc.). The rasterization stage 660 may be configured to utilize the vertices of the geometric primitives to setup a set of plane equations from which various attributes can be interpolated. The rasterization stage 660 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 660 generates fragment data (e.g., interpolated vertex attributes associated with a particular sample location for each covered pixel) that are transmitted to the fragment shading stage 670.

The fragment shading stage 670 processes fragment data by performing a set of operations (e.g., a fragment shader or a program) on each of the fragments. The fragment shading stage 670 may generate pixel data (e.g., color values) for the fragment such as by performing lighting operations or sampling texture maps using interpolated texture coordinates for the fragment. The fragment shading stage 670 generates pixel data that is transmitted to the raster operations stage 680.

The raster operations stage 680 may perform various operations on the pixel data such as performing alpha tests, stencil tests, and blending the pixel data with other pixel data corresponding to other fragments associated with the pixel. When the raster operations stage 680 has finished processing the pixel data (e.g., the output data 602), the pixel data may be written to a render target such as a frame buffer, a color buffer, or the like.

It will be appreciated that one or more additional stages may be included in the graphics processing pipeline 600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 640). Other types of graphics processing pipelines are contemplated as being within the scope of the present disclosure. Furthermore, any of the stages of the graphics processing pipeline 600 may be implemented by one or more dedicated hardware units within a graphics processor such as PPU 300. Other stages of the graphics processing pipeline 600 may be implemented by programmable hardware units such as the SM 440 of the PPU 300.

The graphics processing pipeline 600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 300. The API provides an abstraction for a programmer that lets a programmer utilize specialized graphics hardware, such as the PPU 300, to generate the graphical data without requiring the programmer to utilize the specific instruction set for the PPU 300. The application may include an API call that is routed to the device driver for the PPU 300. The device driver interprets the API call and performs various operations to respond to the API call. In some instances, the device driver may perform operations by executing instructions on the CPU. In other instances, the device driver may perform operations, at least in part, by launching operations on the PPU 300 utilizing an input/output interface between the CPU and the PPU 300. In an embodiment, the device driver is configured to implement the graphics processing pipeline 600 utilizing the hardware of the PPU 300.

Various programs may be executed within the PPU 300 in order to implement the various stages of the graphics processing pipeline 600. For example, the device driver may launch a kernel on the PPU 300 to perform the vertex shading stage 620 on one SM 440 (or multiple SMs 440). The device driver (or the initial kernel executed by the PPU 400) may also launch other kernels on the PPU 400 to perform other stages of the graphics processing pipeline 600, such as the geometry shading stage 640 and the fragment shading stage 670. In addition, some of the stages of the graphics processing pipeline 600 may be implemented on fixed unit hardware such as a rasterizer or a data assembler implemented within the PPU 400. It will be appreciated that results from one kernel may be processed by one or more intervening fixed function hardware units before being processed by a subsequent kernel on an SM 440.

Example Game Streaming System

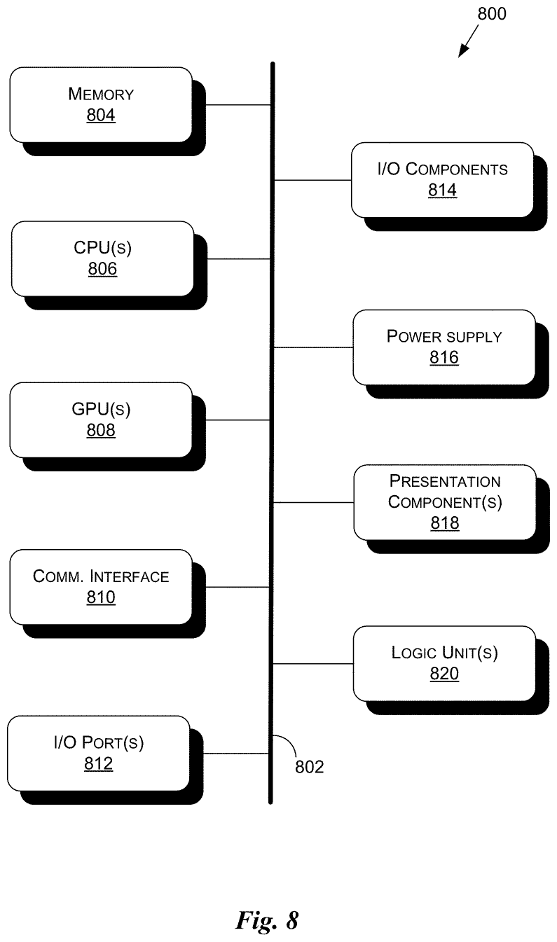

Now referring to FIG. 7, FIG. 7 is an example system diagram for a game streaming system 700, in accordance with some embodiments of the present disclosure. While the present system 700 references an embodiment specific to a gaming application, it should be noted that the description of the system 700 may equally be applied for other graphics-related applications which do not necessary include gaming. FIG. 7 includes game server(s) 702 (which may include similar components, features, and/or functionality to the example computing device 800 of FIG. 8), client device(s) 704 (which may include similar components, features, and/or functionality to the example computing device 800 of FIG. 8), and network(s) 706 (which may be similar to the network(s) described herein). In some embodiments of the present disclosure, the system 700 may be implemented.

In the system 700, for a game session, the client device(s) 704 may only receive input data in response to inputs to the input device(s), transmit the input data to the game server(s) 702, receive encoded display data from the game server(s) 702, and display the display data on the display 724. As such, the more computationally intense computing and processing is offloaded to the game server(s) 702 (e.g., dynamic global illumination during rendering—including ray or path tracing—for graphical output of the game session is executed by the GPU(s) of the game server(s) 702). In other words, the game session is streamed to the client device(s) 704 from the game server(s) 702, thereby reducing the requirements of the client device(s) 704 for graphics processing and rendering.

For example, with respect to an instantiation of a game session, a client device 704 may be displaying a frame of the game session on the display 724 based on receiving the display data from the game server(s) 702. The client device 704 may receive an input to one of the input device(s) and generate input data in response. The client device 704 may transmit the input data to the game server(s) 702 via the communication interface 720 and over the network(s) 706 (e.g., the Internet), and the game server(s) 702 may receive the input data via the communication interface 718. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 712 may render the game session (e.g., representative of the result of the input data) and the render capture component 714 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 702. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an ×86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, etc.), and output the data (e.g., as an image, video, sound, etc.).

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method, comprising:
computing an irradiance field probe of a plurality of irradiance field probes placed in a volume of a scene by:
computing, for the irradiance field probe, a diffuse irradiance and statistics of a distance distribution, and
encoding the irradiance field probe with the diffuse irradiance and the statistics of the distance distribution.

2. The method of claim 1, wherein the method is performed at scene initialization.

3. The method of claim 1, wherein the irradiance field probe stores information about a point in the scene.

4. The method of claim 1, wherein at least a subset of the plurality of irradiance field probes are volumes of different resolutions.

5. The method of claim 1, wherein encoding the irradiance field probe includes packing the diffuse irradiance and the statistics of the distance distribution as square probe textures into a single two-dimensional (2D) texture atlas with duplicated gutter regions.

6. The method of claim 1, wherein the irradiance field probe is encoded by applying a perception-based exponential encoding to probe irradiance values.

7. The method of claim 1, further comprising:
updating one or more irradiance field probes of the plurality of irradiance field probes based on changes to the scene.

8. The method of claim 7, wherein a select one or more irradiance field probes are updated for each frame of a plurality of frames associated with the scene.

9. The method of claim 8, wherein the updating blends results over time.

10. The method of claim 8, wherein each select one or more irradiance field probes are active irradiance field probes of the plurality of irradiance field probes.

11. The method of claim 10, wherein prior to determining the active irradiance field probes of the plurality of irradiance field probes, a placement of each irradiance field probe of the plurality of irradiance field probes is iteratively adjusted as offsets from a three-dimensional (3D) grid over static geometry.

12. The method of claim 7, wherein updating the one or more irradiance field probes includes:
generating and tracing a plurality of primary rays from each irradiance field probe of the one or more irradiance field probes,
storing geometry for surface hits in a buffer having a plurality of surfels with explicit position and normals,
shading intersected surfels with direct and indirect illumination, and
updating the one or more irradiance field probes by blending in an updated irradiance and updated mean and variancostatistics of an updated distance distribution for each of the intersected surfels.

13. The method of claim 7, wherein updating one or more irradiance field probes of the plurality of irradiance field probes based on changes to the scene includes adjusting hysteresis based on a magnitude of lighting or geometry changes.

14. The method of claim 12, wherein intersected surfels are shaded by computing multi-bounce illumination effects with diffuse, glossy, and specular transport.

15. The method of claim 14, wherein rough primary glossy reflections and 2^{nd} through nth order glossy reflections are shaded.

16. The method of claim 12, wherein a single self-shadow bias is used to compute the updated irradiance.

17. The method of claim 1, further comprising:
shading the scene utilizing the plurality of irradiance field probes.

18. The method of claim 1, wherein the statistics include a mean and variance of the distance distribution that is encoded as an average distance and average squared distance.

19. A non-transitory computer-readable media storing computer instructions that, when executed by one or more processors, cause the one or more processors to perform a method comprising:
computing an irradiance field probe of a plurality of irradiance field probes placed in a volume of a scene by:
computing, for the irradiance field probe, a diffuse irradiance and statistics of a distance distribution, and
encoding the irradiance field probe with the diffuse irradiance and the statistics of the distance distribution.

20. A system, comprising:
a memory storing computer instructions; and
one or more processors that execute the computer instructions to perform a method comprising:
computing an irradiance field probe of a plurality of irradiance field probes placed in a volume of a scene by:
computing, for the irradiance field probe, a diffuse irradiance and statistics of a distance distribution, and
encoding the irradiance field probe with the diffuse irradiance and the statistics of the distance distribution.

21. The system of claim 20, wherein the one or more processors are parallel processors that compute the irradiance field probe.

22. A system, comprising:
at least one server in communication with a client device over a network, the at least one server for:
receiving, from the client device, input data associated with a scene;
responsive to the input data, calculating global illumination for the scene including:
computing an irradiance field probe of a plurality of irradiance field probes placed in a volume of the scene by:
computing, for the irradiance field probe, a diffuse irradiance and statistics of a distance distribution, and
encoding the irradiance field probe with the diffuse irradiance and the statistics of the distance distribution;
rendering the scene, based on the global illumination; and
outputting the rendered scene to the client device.

23. The system of claim 22, wherein the scene is associated with a gaming application.

24. The system of claim 22, further comprising:
receiving additional input data associated with changes to the scene; and
updating one or more irradiance field probes of the plurality of irradiance field probes based on the changes to the scene.

25. The method of claim 24, wherein a select one or more irradiance field probes are updated for each frame of a plurality of frames associated with the scene.

26. The method of claim 24, wherein the updating blends results over time.

27. The method of claim 25, wherein each select one or more irradiance field probes are active irradiance field probes of the plurality of irradiance field probes.

28. The method of claim 24, wherein updating the one or more irradiance field probes includes:
generating and tracing a plurality of primary rays from each irradiance field probe of the one or more irradiance field probes,
storing geometry for surface hits in a buffer having a plurality of surfels with explicit position and normals,
shading intersected surfels with direct and indirect illumination, and
updating the one or more irradiance field probes by blending in an updated irradiance and updated statistics of an updated distance distribution for each of the intersected surfels.

29. The method of claim 1, wherein the statistics include a mean and variance of the distance distribution.
